(19) United States
(12) Patent Application Publication
(10) Pub. No.: US 2025/0227369 A1
(43) Pub. Date: Jul. 10, 2025

(54) SHAKE CORRECTION DEVICE

(71) Applicant: FUJIFILM Corporation, Tokyo (JP)

(72) Inventors: Shuhei MATSUSHITA, Saitama (JP); Takuro Abe, Saitama (JP); Kouhei Awazu, Saitama (JP); Atsushi Matsushima, Saitama (JP)

(73) Assignee: FUJIFILM Corporation, Tokyo (JP)

(21) Appl. No.: 19/090,348

(22) Filed: Mar. 25, 2025

Related U.S. Application Data
(63) Continuation of application No. PCT/JP2023/031845, filed on Aug. 31, 2023.

(30) Foreign Application Priority Data
Sep. 26, 2022 (JP) 2022-152750

(51) Int. Cl. H04N 23/68; H01F 7/08; H04N 23/54

(52) U.S. Cl. CPC H04N 23/685; H01F 7/081; H04N 23/54

(57) ABSTRACT

An embodiment according to the technology of the present disclosure provides a shake correction device that corrects a shake by moving a holding member that holds an imaging element. A shake correction device according to an aspect of the present invention includes: an imaging element; a fixed unit that includes a magnet member and a yoke member; and a movable unit that includes a holding member holding the imaging element and a first coil member, the holding member being movably supported, in which the magnet member includes a first magnet and a second magnet, and a first width which is a width of the first magnet is wider than a second width which is a width of the second magnet.

### CROSS-REFERENCE TO RELATED APPLICATIONS

The present application is a Continuation of PCT International Application No. PCT/JP2023/031845 filed on Aug. 31, 2023 claiming priority under 35 U.S.C § 119 (a) to Japanese Patent Application No. 2022-152750 filed on Sep. 26, 2022. Each of the above applications is hereby expressly incorporated by reference, in its entirety, into the present application.

### BACKGROUND OF THE INVENTION

### 1. Field of the Invention

The present invention relates to a shake correction device that is used to perform shake correction of an imaging apparatus.

### 2. Description of the Related Art

Regarding a technology for performing shake correction of an imaging apparatus, for example, JP2021-139949A, JP2019-191405A, and JP2012-242768A disclose a camera shake correction mechanism comprising a fixed unit, a movable unit, a yoke, a coil, and the like.

### SUMMARY OF THE INVENTION

An embodiment according to the technology of the present disclosure provides a shake correction device that corrects a shake by moving a holding member that holds an imaging element.

According to a first aspect of the present invention, there is provided a shake correction device comprising: an imaging element; a fixed unit that includes a magnet member and a yoke member; and a movable unit that includes a holding member holding the imaging element and a first coil member, the holding member being movably supported, in which the magnet member includes a first magnet and a second magnet, and a first width which is a width of the first magnet is wider than a second width which is a width of the second magnet.

According to a second aspect of the present invention, in the shake correction device according to the first aspect, the first width is a length of a shorter side of an outer shape of the first magnet, and the second width is a length of a shorter side of an outer shape of the second magnet.

According to a third aspect, in the shake correction device according to the first or second aspect, a ratio between a first magnetic flux density, which is a magnetic flux density of the first magnet, and a second magnetic flux density, which is a magnetic flux density of the second magnet, falls within a predetermined range.

According to a fourth aspect, in the shake correction device according to the third aspect, the first width and the second width are widths corresponding to the predetermined range.

According to a fifth aspect, in the shake correction device according to the third or fourth aspect, the first magnet and the second magnet are made of the same material.

According to a sixth aspect, in the shake correction device according to any one of the first to fifth aspects, the first magnet is disposed closer to the imaging element than the second magnet is.

According to a seventh aspect, in the shake correction device according to the sixth aspect, the first magnet is disposed in a region in which a first distance, which is a distance between the first magnet and the imaging element, is shorter than a second distance, which is a distance between the second magnet and the imaging element.

According to an eighth aspect, in the shake correction device according to any one of the first to seventh aspects, the yoke member includes a first yoke connected to the magnet member and a second yoke, the second yoke is disposed on a side opposite to the magnet member with the first coil member interposed therebetween, and a first region in which the second yoke covers the first magnet is smaller than a second region in which the second yoke covers the second magnet.

According to a ninth aspect, in the shake correction device according to the eighth aspect, the first region is a region in which the second yoke and the first magnet overlap each other in a case where the first magnet is seen from a side of the second yoke, and the second region is a region in which the second yoke and the second magnet overlap each other in a case where the second magnet is seen from the side of the second yoke.

According to a tenth aspect, in the shake correction device according to the eighth or ninth aspect, a difference between a size of the first region and a size of the second region is changed according to a movable amount of the movable unit.

According to an eleventh aspect, in the shake correction device according to the eighth or ninth aspect, the first magnet and the second magnet are a pair of magnets in which magnetic poles are disposed in opposite directions.

According to a twelfth aspect, in the shake correction device according to any one of the first to tenth aspects, the first magnet, the second magnet, and the movable unit constitute a magnetic circuit.

According to a thirteenth aspect, in the shake correction device according to the twelfth aspect, the movable unit is moved in a plane parallel to an imaging surface of the imaging element by using the magnetic circuit and a current flowing through the first coil member.

According to a fourteenth aspect, the shake correction device according to any one of the first to thirteenth aspects further comprises a biasing member that biases the movable unit toward the fixed unit.

According to a fifteenth aspect, in the shake correction device according to any one of the first to fourteenth aspects, the first width is 1.2 or more and 1.3 or less in a case where the second width is 1.

According to a sixteenth aspect, in the shake correction device according to any one of the third to fifth aspects, the first magnetic flux density is 1.00 or more and 1.025 or less in a case where the second magnetic flux density is set to 1.

According to a seventeenth aspect, in the shake correction device according to any one of the eighth to tenth aspects, a thrust force of the movable unit at an end part of a movable range of the second yoke is decreased as compared with a thrust force of the movable unit at a center of the movable range.

According to an eighteenth aspect, in the shake correction device according to the seventeenth aspect, a degree of the decrease is 20% or less.

According to a nineteenth aspect, in the shake correction device according to any one of the first to eighteenth aspects, the holding member further holds a second coil member, the first coil member is a coil member for moving the movable unit in a first direction, and the second coil member is a coil member for moving the movable unit in a second direction intersecting the first direction.

According to a twentieth aspect, in the shake correction device according to the nineteenth aspect, the second coil member has different shapes at a first end part close to the imaging element and a second end part far from the imaging element.

According to a twenty-first aspect, in the shake correction device according to the twentieth aspect, the second end part has a width narrower than a width of the first end part.

According to a twenty-second aspect, in the shake correction device according to any one of the nineteenth to twenty-first aspects, at least a magnetic sensor is provided inside the second coil member.

According to a twenty-third aspect, in the shake correction device according to any one of the nineteenth to twenty-second aspects, the holding member has a recessed portion in a first holding portion far from the imaging element in a holding portion that holds the first coil member and the second coil member.

### BRIEF DESCRIPTION OF THE DRAWINGS

FIG. 1 is a schematic view of an inside of an imaging apparatus equipped with a shake correction device.

FIG. 2 is a block diagram showing an embodiment of an internal configuration of the imaging apparatus.

FIG. 3 is a front perspective view of the shake correction device.

FIG. 4 is a rear perspective view of the shake correction device.

FIG. 5 is a front perspective view of a fixed unit.

FIG. 6 is a front perspective view showing a layout of magnets.

FIG. 7 is a front perspective view showing a layout of the magnets, coils, an imaging element, and a holding frame.

FIG. 8 is a partial perspective view showing a layout of a yoke, the coils, and the magnets.

FIG. 9 is a diagram showing a layout of the yoke and the magnets.

FIG. 10 is another diagram showing a layout of the yoke and the magnets.

FIG. 11 is still another diagram showing a layout of the yoke and the magnets.

FIG. 12 is a diagram showing a state in which a thrust force is reduced at an end part of a movable range.

FIG. 13 is a diagram showing a relationship between a movable amount and a cutout amount of the yoke.

FIG. 14 is a diagram showing a relationship between the movable amount and the thrust force in a case where a ratio between a first width and a second width is changed.

FIG. 15 is a diagram showing a relationship between a ratio of widths of the magnets and a ratio of magnetic flux densities.

FIG. 16A and FIG. 16B are diagrams respectively showing a layout of a non-uniform coil from different views.

FIG. 17 is a view showing a state in which a movable unit is biased by a biasing member.

FIG. 18 is a diagram showing a state in which the non-uniform coil and a recessed portion of a coil holding frame are used in combination.

FIG. 19 is a diagram showing a bonding location between the coil and the holding frame.

### DESCRIPTION OF THE PREFERRED EMBODIMENTS

Hereinafter, a preferable embodiment of a shake correction device according to the present invention will be described with reference to the accompanying drawings. In the following drawings, in order to make the description easier to understand, depending on the drawings, some members may not be shown, and/or members may be shown with changes in color, line types, or the like.

### [Configuration of Imaging Apparatus]

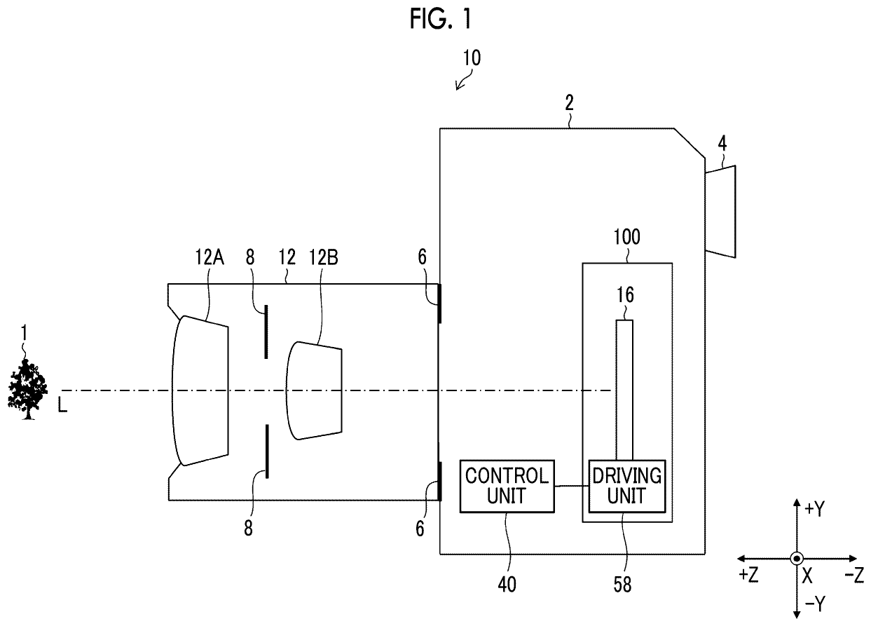

First, an imaging apparatus equipped with a shake correction device will be described. FIG. 1 is a schematic view of an inside of the imaging apparatus that is equipped with the shake correction device of the embodiment of the present invention.

An imaging apparatus 10 is a lens-interchangeable camera, and an imaging lens device 12 is mounted on an imaging apparatus main body 2 via an adapter 6. The imaging lens device 12 comprises a stop 8 and lens groups 12A and 12B. The imaging lens device 12 having an optical axis L forms an image of light reflected by a subject 1. The imaging apparatus main body 2 comprises an eyepiece portion 4, and an imager can place his/her eye on the eyepiece portion 4 to image the subject 1.

On an imaging element 16, a light-receiving surface (imaging surface) is disposed along a plane (X-Y plane) formed by two directions (X direction and Y direction) perpendicular to the optical axis L (Z direction) of the imaging apparatus main body 2. The imaging element 16 is held in the shake correction device 100. Further, a shake correction function is realized by a control unit 40 controlling a driving unit 58 included in the shake correction device 100.

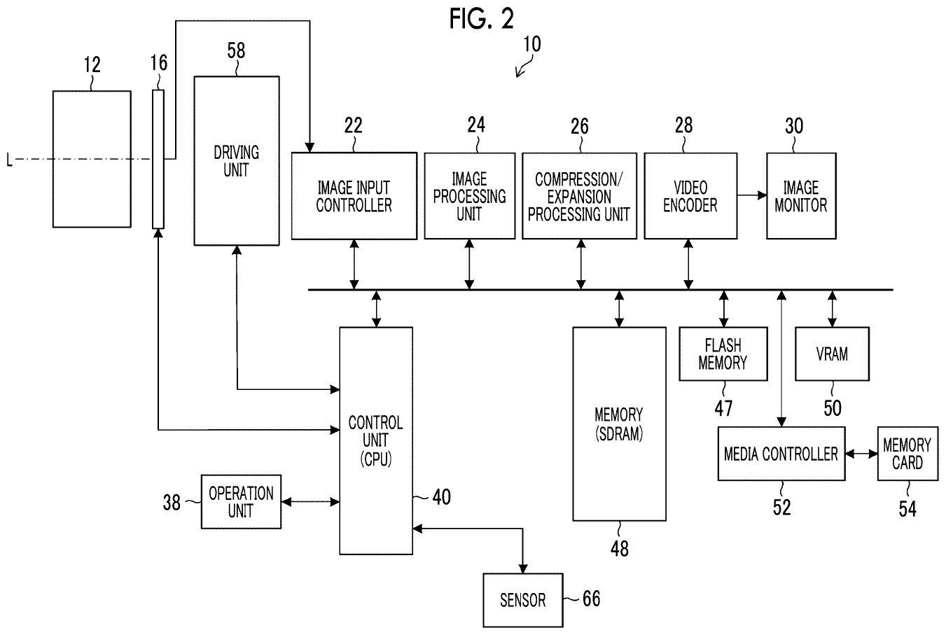

FIG. 2 is a block diagram showing an embodiment of an internal configuration of the imaging apparatus 10. The imaging apparatus 10 records a captured image in a memory card 54, and an operation of the entire apparatus is comprehensively controlled by the control unit 40 comprising a processor such as a central processing unit (CPU).

The imaging apparatus 10 is provided with an operation unit 38, such as a shutter button, a power/mode switch, a mode dial, and a cross operation button. A signal (command) from the operation unit 38 is input to the control unit 40, and the control unit 40 controls each circuit of the imaging apparatus 10 based on the input signal to perform drive control of the imaging element 16, lens drive control, stop drive control, imaging operation control, image processing control, recording/reproduction control of image data, display control of an image monitor 30, and the like.

A luminous flux that has passed through the imaging lens device 12 is imaged on the imaging element 16 (imaging element) which is a complementary metal-oxide semiconductor (CMOS) type color image sensor. The imaging element 16 is not limited to the CMOS type, and another type of image sensor, such as a charge coupled device (CCD) type or an organic imaging element, may be used.

In the imaging element 16, a large number of light-receiving elements (for example, photodiodes) are two-dimensionally arranged, and a subject image formed on the light-receiving surface of each light-receiving element is converted (photoelectrically converted) into a signal voltage (or charge) of an amount corresponding to an amount of incidence rays, and is converted into a digital signal via an analog/digital (A/D) converter in the imaging element 16 to be output.

An image signal (image data) read from the imaging element 16 in a case of capturing a motion picture or a still picture is temporarily stored in a memory 48 (for example, a synchronous dynamic random access memory (SDRAM)) via an image input controller 22.

Further, a flash memory 47 stores various parameters and tables used for a camera control program, image processing, and the like.

A sensor 66 is a camera shake sensor and detects posture information and posture change information of the imaging apparatus 10. The sensor 66 is configured of, for example, a gyro sensor. The sensor 66 is configured of, for example, two gyro sensors to detect a camera shake amount in a vertical direction (+Y, −Y direction) and a camera shake amount in a horizontal direction (+X, −X direction), and the detected camera shake amount (angular velocity) is input to the control unit 40. The control unit 40 performs shake correction by controlling the driving unit 58 to move the imaging element 16 such that the movement of the subject image corresponding to the camera shake is canceled. A gyro sensor for detecting a camera shake amount in a rotation direction (for example, around a Z axis) may be provided in the sensor 66, and the shake correction may be performed so as to cancel the camera shake in the rotation direction.

The driving unit 58 (driving mechanism) is controlled by the control unit 40. The driving unit 58 is composed of a voice coil motor (VCM) or the like described below.

An image processing unit 24 reads unprocessed image data that is acquired via the image input controller 22 in a case of capturing a motion picture or a still picture and temporarily stored in the memory 48. The image processing unit 24 performs offset processing, pixel interpolation processing (interpolation processing for a phase difference detecting pixel, a defective pixel, and the like), white balance correction, gain control processing including sensitivity correction, gamma-correction processing, synchronization processing (also called “demosaicing”), brightness and color difference signal generation processing, edge enhancement processing, color correction, and the like on the read image data. The image data that is processed by the image processing unit 24 and is processed as a live view image is input to a video random access memory (VRAM) 50.

The image data read from the VRAM 50 is encoded by a video encoder 28 and output to the image monitor 30 provided on a rear surface of the camera. Accordingly, the live view image showing the subject image is displayed on the image monitor 30.

The image data that is processed by the image processing unit 24 and is processed as a still picture or motion picture for recording (brightness data (Y) and color difference data (Cb), (Cr)) is stored again in the memory 48.

A compression/expansion processing unit 26 performs compression processing on the brightness data (Y) and the color difference data (Cb), (Cr) processed by the image processing unit 24 and stored in the memory 48 in a case of recording a still picture or a motion picture. The compressed image data is recorded in the memory card 54 via a media controller 52.

Further, the compression/expansion processing unit 26 performs expansion processing on the compressed image data obtained from the memory card 54 via the media controller 52 in a playback mode. The media controller 52 performs recording, reading, or the like of the compressed image data to and from the memory card 54.

In the above embodiment, a hardware structure of a processing unit such as the control unit 40 that executes various kinds of processing includes various processors to be described below. The various processors include a central processing unit (CPU) that is a general-purpose processor functioning as various processing units by executing software (program), a programmable logic device (PLD) such as a field programmable gate array (FPGA) that is a processor having a circuit configuration changeable after manufacture, a dedicated electric circuit such as an application specific integrated circuit (ASIC) that is a processor having a circuit configuration dedicatedly designed to execute specific processing, and the like.

One processing unit may be configured of one of these various processors, or may be configured of two or more same type or different types of processors (for example, a plurality of FPGAs or a combination of the CPU and the FPGA). In addition, a plurality of processing units may be configured of one processor. As an example of configuring the plurality of processing units by one processor, first, there is a form in which one processor is configured of a combination of one or more CPUs and software, as typified by a computer such as a client or a server, and the one processor functions as the plurality of processing units. Second, there is a form in which a processor that realizes functions of an entire system including a plurality of processing units with one integrated circuit (IC) chip is used, as typified by a system on chip (SoC) or the like. As described above, the various processing units are configured using one or more of the above various processors as a hardware structure.

Furthermore, the hardware structure of those various processors is more specifically an electric circuit (circuitry) in which circuit elements such as semiconductor elements are combined.

### [Outline of Shake Correction Device]

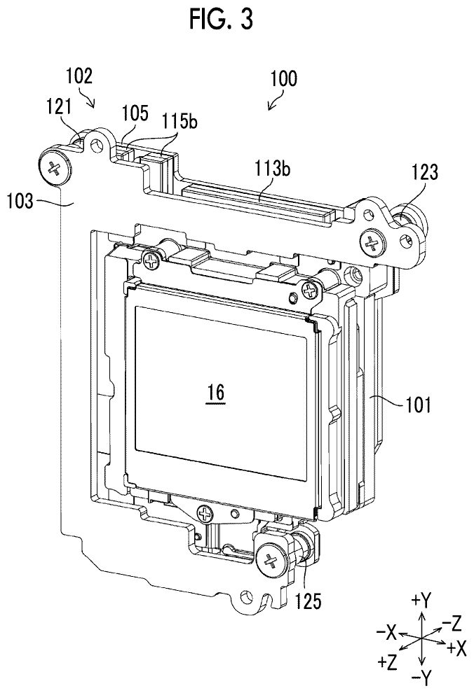

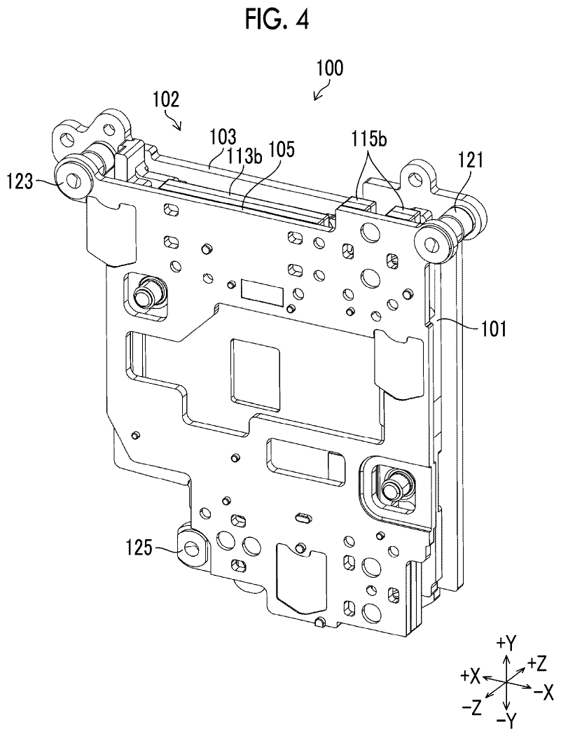

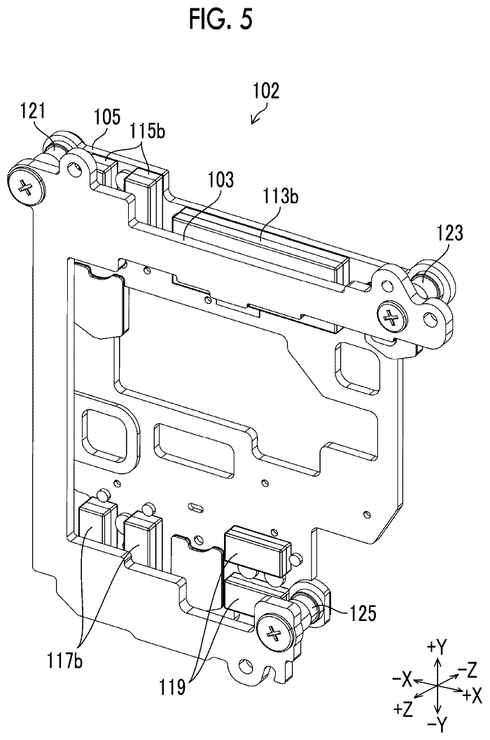

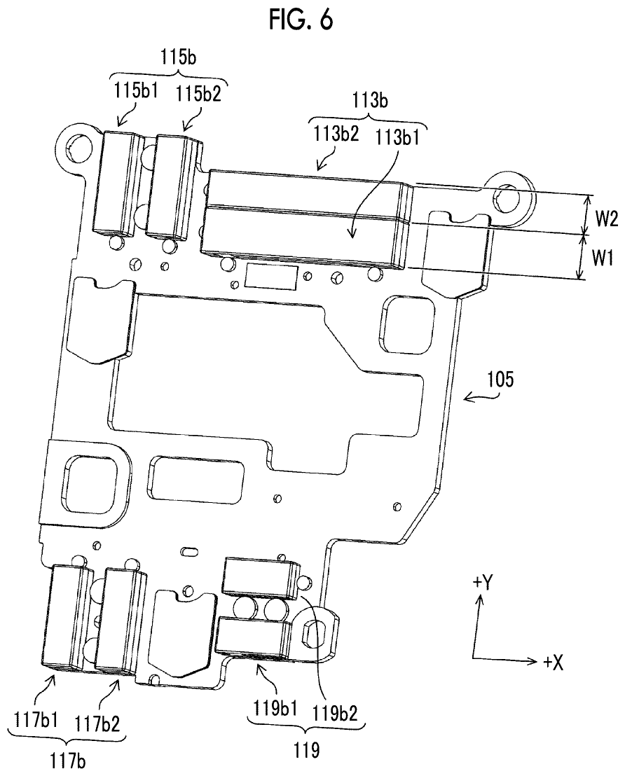

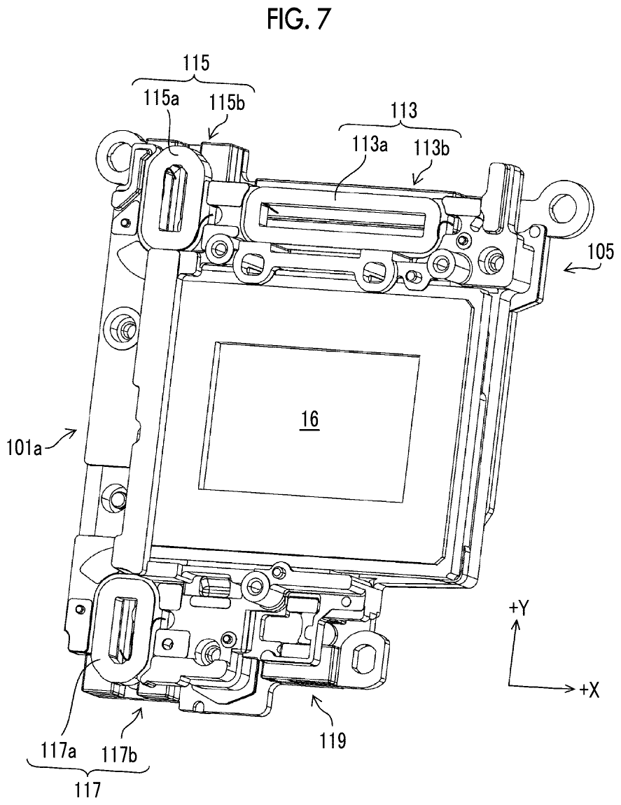

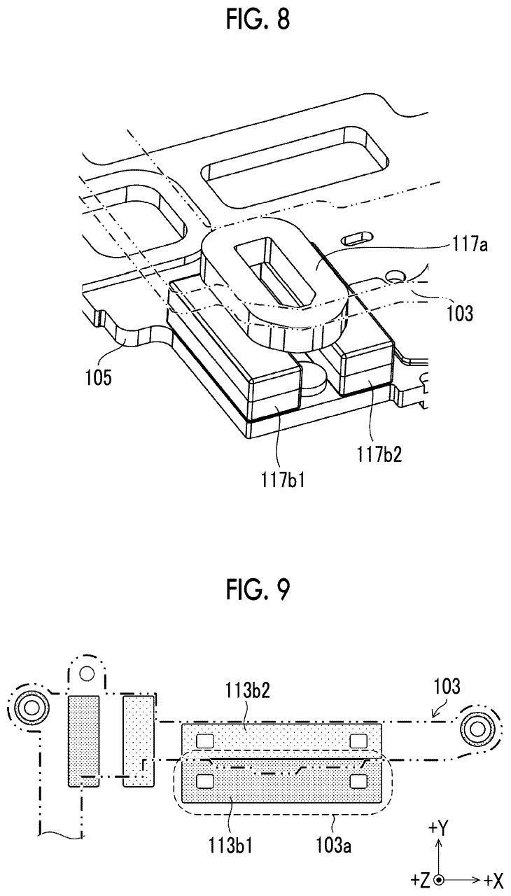

Next, an outline of the shake correction device 100 will be described. FIGS. 3 to 8 are views showing the shake correction device 100 (shake correction device) mounted on the imaging apparatus 10 (imaging apparatus). FIG. 3 is a front perspective view of the shake correction device 100, FIG. 4 is a rear perspective view of the shake correction device 100, and FIG. 5 is a front perspective view of a fixed unit 102. In addition, FIG. 6 is a front perspective view showing a layout of magnets, FIG. 7 is a front perspective view showing a layout of the magnets, coils, the imaging element, and a holding frame, and FIG. 8 is a partial perspective view showing a layout of a yoke, the coils, and the magnets. In the following description, a “front surface” is a surface seen from a +Z side (subject side), and a “rear surface” is a surface seen from a −Z side (imager side).

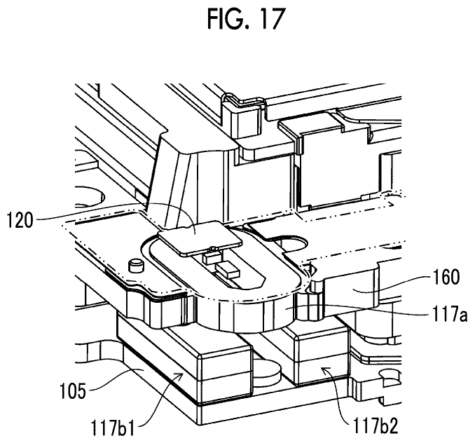

The shake correction device 100 is mainly composed of a movable unit 101 (movable unit) on which the imaging element 16 (imaging element) is mounted, and the fixed unit 102 (fixed unit) that is fixed to the imaging apparatus main body 2. The movable unit 101 is in contact with the fixed unit 102 via a ball (not shown). In addition, the movable unit 101 is biased toward a first yoke 105 (fixed unit 102) by a biasing force of a magnetic spring plate 120 (biasing member; see FIGS. 11 and 17) described below, and the ball described above is sandwiched between the movable unit 101 and the fixed unit 102. The movable unit 101 can move and/or rotate in a plane (X-Y plane) perpendicular to the optical axis L (Z axis), that is, in a plane parallel to the imaging surface of the imaging element 16.

### [Structure of Fixed Unit]

The fixed unit 102 is composed of the first yoke 105 (yoke member, first yoke) and a second yoke 103 (yoke member, second yoke), and is fixed to the imaging apparatus main body 2 by a mechanism (not shown). The first yoke 105 is disposed on the imager side (−Z side), and the second yoke 103 is disposed on the subject 1 side (+Z side). The first yoke 105 is disposed at a position facing the second yoke 103 in a state of being spaced apart from the second yoke 103 by shafts 121, 123, and 125. These shafts also function as movable end stoppers on the fixed unit 102 side.

The first yoke 105 is connected to a magnet 113b (magnet member: first magnet and second magnet), a magnet 115b, a magnet 117b, and a magnet 119, and the second yoke 103 is disposed on a side opposite to these magnets (magnet members) with a coil such as a coil 113a (first coil member) interposed therebetween. These magnets include a pair of magnets in which magnetic poles are disposed in opposite directions, as will be described in detail below.

As shown in FIGS. 6 and 7, the magnet 113b and the coil 113a provided in the movable unit 101 constitute a voice coil motor 113 (VCM). The magnet 115b and a coil 115a provided in the movable unit 101 constitute a voice coil motor 115 (VCM). The magnet 117b and a coil 117a provided in the movable unit 101 constitute a voice coil motor 117 (VCM). In addition, the magnet 115b, the magnet 117b, and the magnet 119 are also used as magnets for a Hall element (magnetic sensor) that detects a position of the movable unit 101. In addition, the magnet 113b is a dedicated magnet for the voice coil motor 113. The voice coil motor 113, the voice coil motor 115, and the voice coil motor 117 constitute the driving unit 58 (see FIGS. 1 and 2).

### [Structure of Movable Unit]

As shown in FIG. 7, the movable unit 101 comprises a holding frame 101a (holding member). The holding frame 101a holds the imaging element 16, the coil 113a, the coil 115a, the coil 117a, and the like, and the holding frame 101a is movably supported by the above-described ball and the like.

### [Magnetic Circuit]

The coil 113a (first coil member) is a coil member for moving the movable unit 101 (movable unit) in a +Y direction or a −Y direction (first direction), and the coils 115a and 117a (second coil members) are coil members for moving the movable unit 101 (movable unit) in the X direction (+X direction, −X direction: second direction) perpendicular (an aspect of intersection) to the Y direction (+Y direction, −Y direction). In addition, the magnet 113b (first magnet and second magnet), the magnet 115b, the magnet 117b, and the magnet 119 include a pair of magnets in which magnetic poles are disposed in opposite directions, and these magnets and the movable unit 101 constitute a magnetic circuit (closed circuit including a magnetic flux). The magnetic circuit also includes the voice coil motors 113, 115, and 117 and the magnetic spring plate 120 (see FIGS. 11 and 17) described below.

The “pair of magnets in which the magnetic poles are disposed in opposite directions” means, for example, that one magnet of the pair of magnets constituting the magnets 113b, 115b, 117b, and 119 is disposed such that an N pole is on the +Z side, the other magnet is disposed such that an S pole is on the +Z side, and magnetic field lines are directed from the N pole to the S pole. Specifically, as shown in FIG. 6, the magnet 113b includes a pair of magnet 113b1 (first magnet) and magnet 113b2 (second magnet). In FIG. 6, the magnet 113b1 can be disposed such that an S pole is on the +Z side, and the magnet 113b2 can be disposed such that an N pole is on the +Z side. The magnet 113b1 is disposed closer to the imaging element 16 than the magnet 113b2 is. The magnet 113b1 has a width w1 (first width; a length of a shorter side of an outer shape of the magnet 113b1), and the magnet 113b1 has a width w2 (second width; a length of a shorter side of an outer shape of the magnet 113b2). Similarly, the magnet 115b can be disposed such that a magnet 115b1 has an S pole on the +Z side and a magnet 115b2 has an N pole on the +Z side, the magnet 117b can be disposed such that a magnet 117b1 has an S pole on the +Z side and the magnet 117b2 has an N pole on the +Z side, and the magnet 119 can be disposed such that a magnet 119b1 has an S pole on the +Z side and a magnet 119b2 has an N pole on the +Z side. An orientation of these magnets is an example, and the magnets may be disposed in an orientation opposite to the above-described orientation.

In addition, the magnet 113b1 (first magnet) is disposed closer to the imaging element 16 than the magnet 113b2 (second magnet) is. Specifically, the magnet 113b1 is disposed in a region in which a first distance (distance in the Y direction in FIG. 6) that is a distance between the magnet 113b1 and the imaging element 16 is shorter than a second distance (distance in the Y direction in FIG. 6) that is a distance between the magnet 113b2 and the imaging element 16.

### [Movement and Rotation of Movable Unit by Magnetic Circuit]

The movable unit 101 can be moved in a plane (in the X-Y plane) parallel to the imaging surface of the imaging element 16 by using the magnetic circuit described above and a current flowing through the coils (coils 113a, 115a, and 117a). In addition, the movable unit 101 can be rotated in a plane parallel to the imaging surface of the imaging element 16 (around the Z axis) by changing a drive amount in an X-axis direction (+X direction or −X direction) by the voice coil motor 115 and a drive amount in the X-axis direction (+X direction or −X direction) by the voice coil motor 117. In a case where a camera shake or the like occurs, the movable unit 101 is driven in a direction in which the camera shake is canceled by the voice coil motor 113, the voice coil motor 117, and the voice coil motor 115, and thus, an influence of the camera shake can be suppressed in an image acquired by the imaging element 16 mounted on the movable unit 101.

The movable unit 101 has a ball housing portion (not shown) that houses the above-described ball on a surface on the first yoke 105 side. The ball housing portion is movable with rolling of the ball, and thus the movable unit 101 can freely move and/or rotate (rotation around the Z axis) on a plane (X-Y plane) perpendicular to the optical axis L (that is, in a plane parallel to the imaging surface of the imaging element 16). The first yoke 105A is provided with a ball receiving surface (not shown) on the fixed unit 102 side.

Regarding a layout of the device and the movement of the movable unit 101 in the shake correction device 100, the Y-axis direction may be described as an “up-down direction” (the +Y direction is “up” and the −Y direction is “down”), and the X-axis direction may be described as a “left-right direction” (the +X direction is “right” and the −X direction is “left”).

### [Details of Shake Correction Device]

### [Reduction in Size of Actuator and Ensuring Thrust Force]

In recent years, there has been a demand for a small, lightweight, and high-performance camera. While a camera is required to be equipped with a large-sized and high-pixel imaging element (CMOS or the like) or a shake correction device, it is necessary to achieve both these configurations and the reduction in size of the shake correction device for suppressing the size thereof. The shake correction device has an actuator and a sensor in order to perform camera shake correction by moving and/or rotating the imaging element. For example, a voice coil motor (VCM) is used as the actuator, and a magnetic sensor (a Hall element or the like) is used as the sensor. Since a size of a magnetic circuit including the VCM and the magnetic sensor determines the size of the shake correction device, it is important to optimize a layout of the components and to achieve the reduction in size. In a case where the magnetic circuit of the VCM and the magnetic sensor is shared, the size can be reduced, and in a case where magnetic circuit components are disposed in the up-down direction of the imaging element, a side surface of the imaging element can be reduced in size. In a case where a space is created on the side surface of the imaging element, other units can be disposed at a high density, which leads to a reduction in size of the camera.

However, in a case where the magnetic circuit is reduced in size, a thrust force of the VCM and a position detection accuracy of the magnetic sensor tend to be reduced. Therefore, in order to achieve both of required magnetic circuit performance and a reduction in size, a fine magnetic circuit design is preferable. In order to avoid a magnetic interference between the magnetic circuit and a shutter motor around the shake correction device and to prevent a decrease in thrust force, for example, as shown in FIGS. 6 and 7, it is desirable that the VCM has such a layout that “one VCM component (voice coil motor 113 for driving in the up-down direction) is disposed on a side opposite (+Y side) opposite to the shutter motor (not shown) and VCM components (voice coil motors 115 and 117) for driving in the left-right direction are disposed one each on the upper side (+Y side of the −X side) and the lower side (−Y side of the −X side)”. In order to increase the thrust force, it is desirable to make a circuit having a high magnetic flux density in which a pair of the magnets of the fixed unit 102, the coils of the movable unit 101, and the yokes (the first yoke 105 and the second yoke 103) of the fixed unit 102 overlap each other in an optical axis direction. However, in a case where the magnetic circuit is reduced in size, the second yoke 103 on the imaging element 16 side is inevitably provided with a cutout for avoiding a mechanical interference with the movable unit 101.

### [Cutout of Yoke and Magnet Having Asymmetrical Shape]

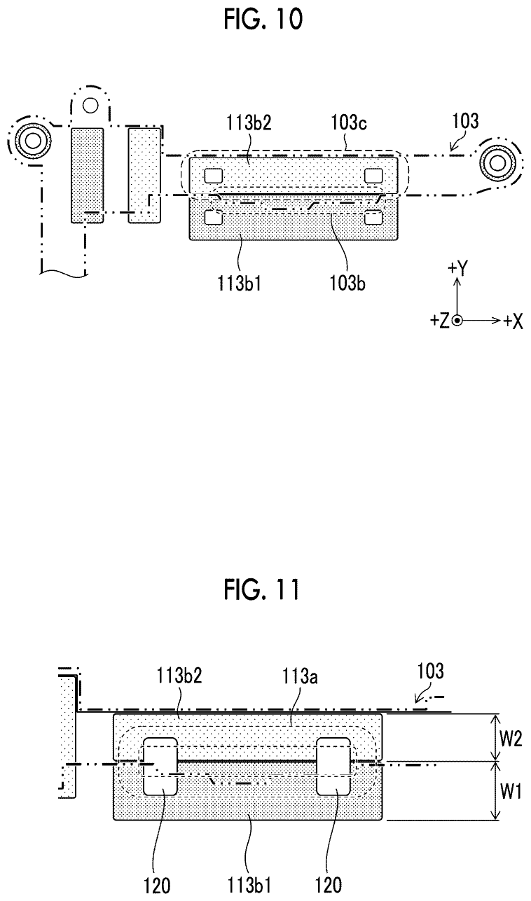

FIGS. 9 to 11 are diagrams showing a layout of the yoke and the magnets. In the shake correction device 100 according to the present embodiment, as shown in FIGS. 9 to 11, the second yoke 103 is provided with a cutout portion 103a, and a first region 103b (first region) in which the second yoke 103 covers the magnet 113b1 (first magnet) is smaller than a second region 103c (second region) in which the second yoke 103 covers the magnet 113b2 (second magnet). As shown in FIG. 10, the first region 103b is a region in which the second yoke 103 and the magnet 113b1 overlap each other in a case where the magnet 113b1 (first magnet) is seen from the side of the second yoke 103 (+Z direction), and the second region 103c is a region in which the second yoke 103 and the magnet 113b2 overlap each other in a case where the magnet 113b2 is seen from the side of the second yoke 103 (+Z direction).

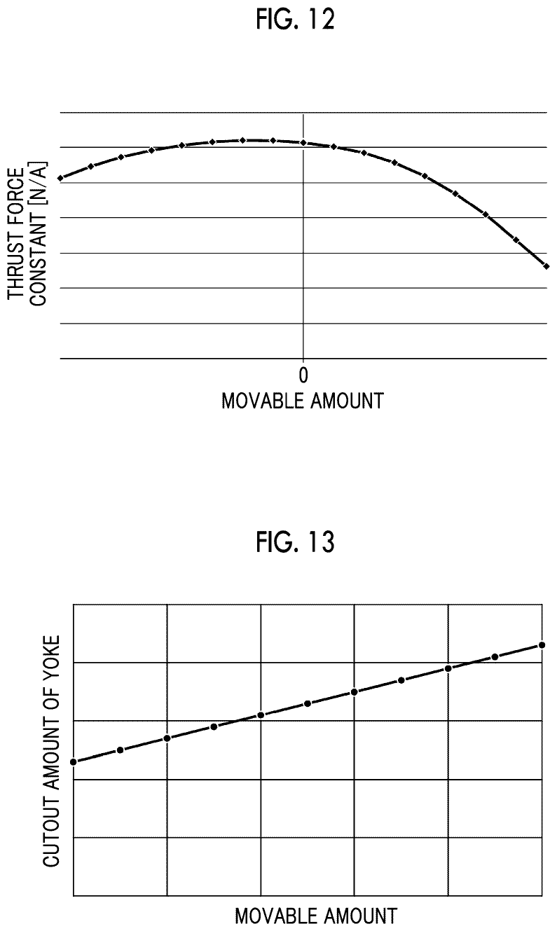

Therefore, on the magnet 113b2 side (for example, the N-pole side), the magnet and the second yoke 103 overlap in the optical axis direction, resulting in a high magnetic flux density, while on the magnet 113b1 side (for example, the S-pole side), the cutout portion 103a is present, resulting in a low magnetic flux density. Since a difference in magnetic flux density occurs between the N-pole side and the S-pole side, the thrust force in the up-down direction (Y direction) becomes unbalanced and asymmetric, and the thrust force at an end part of a movable range of the second yoke 103 (second yoke) is lower than the thrust force at a center of the movable range (also referred to as “thrust force drop”). For example, as shown in FIG. 12, the thrust force decreases by 30% or more at an end part (near a right end of a graph) of the movable range as compared with the center (position where a movable amount is 0) of the movable range. In a case where the thrust force decreases, the movable unit cannot be controlled, and camera shake correction does not work.

Since a design size of the shake correction device is determined by a region obtained by subtracting a peripheral unit from a target size of the camera, a design size region of the pair of magnets and the yoke of the fixed unit 102 is also determined. The cutout of the yoke is determined by the movable amount, and as shown in FIG. 13, a cutout amount increases linearly as the movable amount increases (a difference between a size of the first region 103b and a size of the second region 103c is changed according to the movable amount of the movable unit 101).

### [Ratio of Magnetic Flux Density and Width of Magnet]

In order to design the VCM in which a decrease in thrust force is small within the movable range even in a case where the yoke has a cutout, it is desirable to optimally combine the width w1 (first width) of the magnet 113b1 (first magnet) and the width w2 (second width) of the magnet 113b2 (second magnet) and the size of the second yoke 103 such that the magnetic flux densities on the N-pole side and the S-pole side are as equal as possible within the determined magnet width and yoke width. In order to achieve both the prevention of the decrease in thrust force and the maximization of the thrust force, it is more desirable to design the magnet width and the yoke width to be maximum widths in a determined design size region. The magnet width, which is a sum of the first width and the second width, and the yoke width are designed to be the maximum widths to maximize an overlapping area and maximize the thrust force while “width w1 of magnet 113b1>width w2 of magnet 113b2” (the first width is wider than the second width), that is, the magnet 113b is designed to have an asymmetrical shape and the size of the magnet width is adjusted for fitting such that the magnetic flux density on the magnet 113b1 side is equal to (or approximately equal to) the magnetic flux density on the magnet 113b2 side. Therefore, it is possible to design the VCM in which the decrease in thrust at the end part of the movable range is small (for example, in a case where the thrust force at the end part of the movable range is compared with the thrust force at the center, a degree of decrease in thrust force is 20% or less).

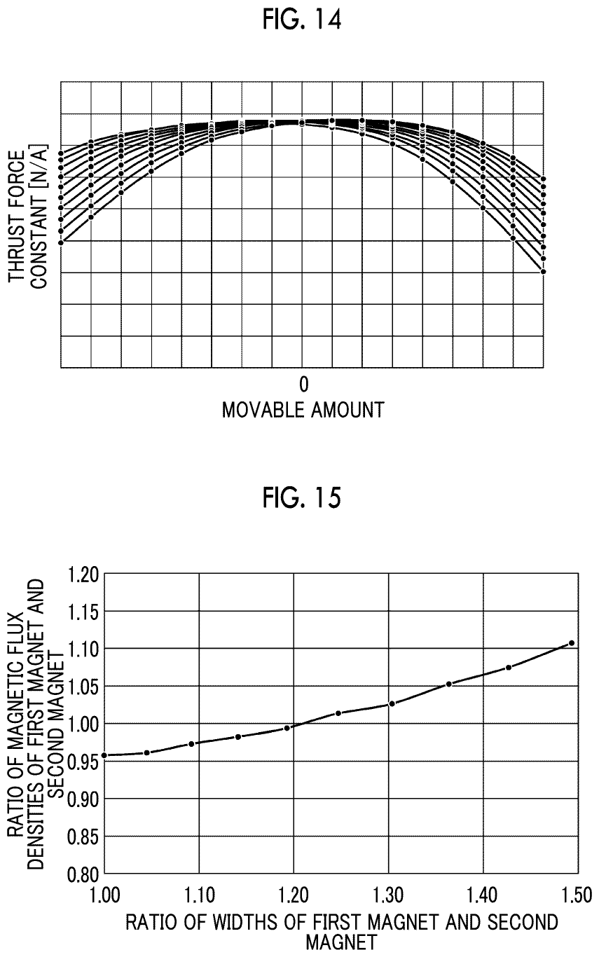

It is desirable to distribute the first width and the second width such that a ratio between the magnetic flux density on the magnet 113b1 side and the magnetic flux density on the magnet 113b2 side falls within a predetermined range (the first width and the second width are set to widths corresponding to the “predetermined range” of the ratio of the magnetic flux densities). FIG. 14 is a diagram showing a relationship between a movable amount and a thrust force in a case where a ratio between the first width and the second width is changed, and each curve in the diagram shows the thrust force in a case where the ratio between the first width and the second width is changed. From FIG. 14, it can be seen that a degree of decrease in thrust force at the end part of the movable range (near an end part of the graph) also changes by changing the ratio between the first width and the second width.

FIG. 15 is a diagram showing a relationship between the ratio of the widths of the magnets and the ratio of the magnetic flux densities. It can be seen from FIG. 15 that, in order to make a ratio (first magnetic flux density in a case where the second magnetic flux density is set to 1) between the magnetic flux density (first magnetic flux density) on the magnet 113b1 side and the magnetic flux density (second magnetic flux density) on the magnet 113b2 side be 1.00 or more and 1.025 or less (an example of a “predetermined range”), it is preferable that the ratio (first width/second width) of the first width to the second width is 1.2 or more and 1.3 or less (a ratio corresponding to a range of the ratio of the magnetic flux densities). It is more preferable that the ratio of the first width to the second width is made close to 1.25.

As described above, since the cutout portion 103a is provided in the second yoke 103 and the “first width>second width” is satisfied (the asymmetric yoke and the asymmetric magnet are used in combination), it is possible to achieve both ensuring the required thrust force and the reduction in size of the imaging apparatus. In the above-described aspect, it is assumed that materials of the magnet 113b1 (first magnet) and the magnet 113b2 (second magnet) are the same, but the ratio of the magnetic flux densities may be changed by changing the material of the magnet, or the ratio of the magnetic flux densities may be changed by combining the change in the shape and the change in the material.

### [Use of Non-Uniform Coil]

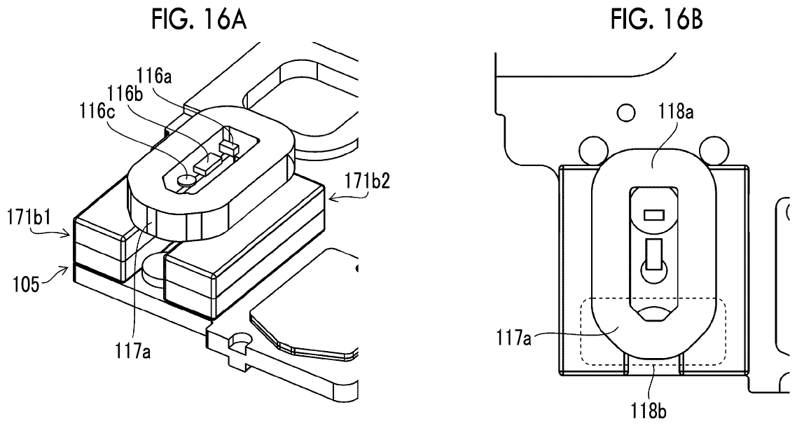

In addition to the above-described combination of the asymmetry, in a case where a pair of magnets of the fixed unit are shared in the magnetic circuit of the VCM and the Hall element, further reduction in size can be achieved. Further, in a case where three of a Hall element (magnetic sensor), a thermistor, and a land of a flexible substrate for soldering a coil winding are disposed inside the coil, further reduction in size is achieved. For example, as shown in FIG. 16A, it is preferable that a thermistor 116a, a hall element 116b (one aspect of the magnetic sensor), and a land 116c are provided inside the coil 117a (second coil member). It is preferable that at least the Hall element (magnetic sensor) is provided inside the coil among these three elements. The same layout is applied to the coil 115a (second coil member).

It is desirable to reduce an outer shape of the coil while maintaining the minimum size of an inner shape of the coil capable of mounting the three elements, but there is a trade-off with a decrease in thrust force due to the reduction in size of the coil. Therefore, by changing the shape of the coil from a rectangular shape (symmetrical shape such as an elliptical shape) to a non-uniform shape (asymmetrical shape), it is possible to design a VCM in which the decrease in thrust force is suppressed while achieving the reduction in size (for example, the decrease in thrust force in the entire movable range is 10% or less). Specifically, it is desirable that an end part of the second coil member on a side far from the imaging element 16 is made non-uniform (the second coil member has different shapes at a first end part close to the imaging element and a second end part far from the imaging element). For example, as shown in FIG. 16B, in the coil 117a (second coil member), it is preferable that an end part 118b (second end part) far from the imaging element 16 has a narrower width than an end part 118a (first end part) close to the imaging element. This is because the end part on the side far from the imaging element 16 is more affected by the size of the shake correction device than the end part on the side close to the imaging element 16. It is preferable that such a non-uniform coil is also used for the coil 115a (second coil member) in the same manner.

In a case where the size is adjusted in the optical axis direction, such as by increasing a height (height in the Z direction) of the magnet or reducing a gap between the coil and the magnet by an amount of reduction in thrust force, it is possible to achieve both ensuring the required thrust and the reduction in size of the imaging apparatus.

### [Biasing of Movable Unit]

In addition to the above-described configuration, it is desirable to bias the movable unit 101 toward the fixed unit 102 by a magnetic biasing member in order to reduce a size of a shake correction mechanism. In a case where the magnet of the fixed unit 102 is disposed to be superimposed on the coil of the movable unit 101 and the biasing member in the optical axis direction by sharing the magnetic circuit of the VCM, the Hall element, and the like, the size of the shake correction device 100 can be reduced. FIG. 17 is a diagram showing an example in which the magnetic spring plate 120 (an example of the biasing member) biases the movable unit 101 toward the first yoke 105 of the fixed unit 102 (the number of magnetic spring plates 120 is an example).

### [Combination of Non-Uniform Coil and Recessed Portion of Coil Holding Frame]

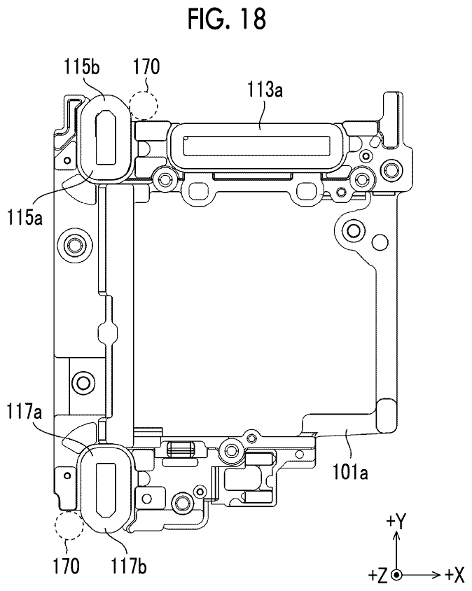

The coils (coils 113a, 115a, and 117a) are assembled to the holding frame 101a (holding member) that holds the imaging element 16. However, in a case where holes corresponding to outer shapes of the coils are formed in the holding frame 101a and the coils are bonded and fixed with an ultraviolet (UV) curable adhesive, the movable unit 101 can be reduced in size. The holding frame 101a is produced by, for example, die casting. However, in a case where the holding frame 101a is produced by resin molding and combined with the above-described non-uniform coil, further reduction in size can be achieved. As shown in FIG. 18, in a portion (holding portion), which holds the coil, of the holding frame 101a, a recessed portion 170 (a recessed portion or a cutout) is partially provided in a portion (first holding portion) where the coil is made non-uniform (in end parts of the coil 115a and the coil 117a that are far from the imaging element 16). As a result, it is possible to reduce the size of the shake correction device and thus the imaging apparatus.

### [Bonding of Coil and Holding Frame by UV Curable Adhesive]

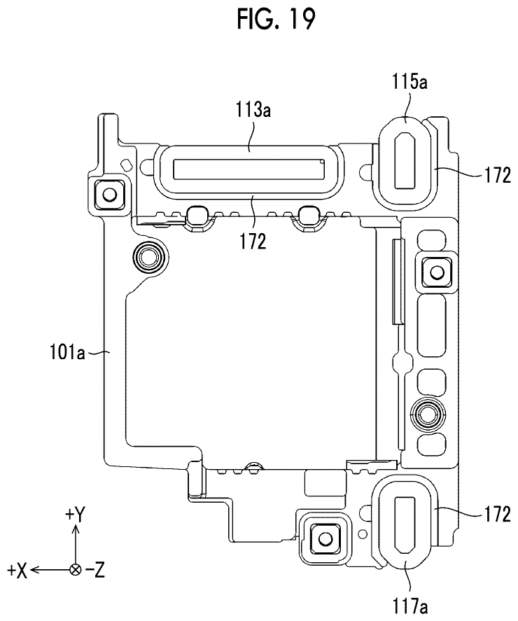

In order to prevent a decrease in strength of the movable unit due to a resin material and a large cutout portion and to ensure a sufficient strength against creep due to dropping and magnetic attractive force, it is desirable to increase a rigidity by bonding the coils (coils 113a, 115a, and 117a) and the holding frame 101a with a UV curable adhesive having a high Young's modulus (for example, 150 MPa or more) and a high glass transition point (for example, 40° C. or more). FIG. 19 (showing a state in which the holding frame 101a shown in FIG. 18 is seen from the −Z side) is a diagram showing a bonding location (adhesion region 172) between the coil and the holding frame using the UV curable adhesive. Although the rigidity of the holding frame 101a alone is reduced due to the reduction in size by providing the recessed portion 170 in the holding frame 101a, changes in performance of the VCM and the Hall element (magnetic sensor) can be suppressed by increasing the rigidity of the holding frame 101a after the coil is bonded and ensuring the strength of the movable unit 101.

Hereinbefore, the embodiment of the present invention has been described above, but the present invention is not limited to the above-described aspects, and various modifications can be made. For example, in the above-described embodiment, a case where the coils 115a and 117a (second coil members) for driving in the +X direction or the −X direction are made non-uniform has been described, but the coil 113a (first coil member) for driving in the +Y direction or the −Y direction may be made non-uniform. Specifically, in a case where the coil 113a is made non-uniform, the width of the end part on the +Y side may be narrowed, or the width of the end part on the +X side or the −X side may be narrowed. In addition, a recessed portion or a cutout may be provided in the holding frame 101a in accordance with the non-uniform shape (in accordance with which end part is narrowed). Specifically, a recessed portion or a cutout may be partially provided in a portion (for example, the end part of the coil 113a on a side far from the imaging element 16) of the holding frame 101a where the coil is made non-uniform. It is possible to decide which form is adopted for the non-uniform shape of the coil and the cutout of the holding frame in accordance with “which side is desired to be reduced in size in relation to a layout of equipment”.

### EXPLANATION OF REFERENCES

1: subject
2: imaging apparatus main body
4: eyepiece portion
6: adapter
8: stop
10: imaging apparatus
12: imaging lens device
12A: lens group
16: imaging element
22: image input controller
24: image processing unit
26: compression/expansion processing unit
28: video encoder
30: image monitor
38: operation unit
40: control unit
47: flash memory
48: memory
52: media controller
54: memory card
58: driving unit
66: sensor
100: shake correction device
101: movable unit
101a: holding frame
102: fixed unit
103: second yoke
103a: cutout portion
103b: first region
103c: second region
105: first yoke
107: ball housing portion
113: voice coil motor
113a: coil
113b: magnet
113b1: magnet
113b2: magnet
115: voice coil motor
115a: coil
115b: magnet
115b1: magnet
115b2: magnet
116a: thermistor
116b: Hall element
116c: land
117: voice coil motor
117a: coil
117b: magnet
117b1: magnet
117b2: magnet
118a: end part
118b: end part
119: magnet
119b1: magnet
119b2: magnet
120: magnetic spring plate
121: shaft
123: shaft
125: shaft
170: recessed portion
172: adhesion region
L: optical axis

What is claimed is:

1. A shake correction device comprising:
an imaging element;
a fixed unit that includes a magnet member and a yoke member; and
a movable unit that includes a holding member holding the imaging element and a first coil member, the holding member being movably supported,
wherein the magnet member includes a first magnet and a second magnet,
the first magnet and the second magnet are disposed on the same plane perpendicular to an optical axis of the imaging element, and
a first width which is a width of the first magnet is wider than a second width which is a width of the second magnet.

2. The shake correction device according to claim 1,
wherein the first width is a length of a shorter side of an outer shape of the first magnet, and
the second width is a length of a shorter side of an outer shape of the second magnet.

3. The shake correction device according to claim 1,
wherein a ratio between a first magnetic flux density, which is a magnetic flux density of the first magnet, and a second magnetic flux density, which is a magnetic flux density of the second magnet, falls within a predetermined range.

4. The shake correction device according to claim 3,
wherein the first width and the second width are widths corresponding to the predetermined range.

5. The shake correction device according to claim 3,
wherein the first magnet and the second magnet are made of the same material.

6. The shake correction device according to claim 1,
wherein the first magnet is disposed closer to the imaging element than the second magnet is.

7. The shake correction device according to claim 6,
wherein the first magnet is disposed in a region in which a first distance, which is a distance between the first magnet and the imaging element, is shorter than a second distance, which is a distance between the second magnet and the imaging element.

8. The shake correction device according to claim 1,
wherein the yoke member includes a first yoke connected to the magnet member and a second yoke,
the second yoke is disposed on a side opposite to the magnet member with the first coil member interposed therebetween, and
a first region in which the second yoke covers the first magnet is smaller than a second region in which the second yoke covers the second magnet.

9. The shake correction device according to claim 8,
wherein the first region is a region in which the second yoke and the first magnet overlap each other in a case where the first magnet is seen from a side of the second yoke, and
the second region is a region in which the second yoke and the second magnet overlap each other in a case where the second magnet is seen from the side of the second yoke.

10. The shake correction device according to claim 8,
wherein a difference between a size of the first region and a size of the second region is changed according to a movable amount of the movable unit.

11. The shake correction device according to claim 1,
wherein the first magnet and the second magnet are a pair of magnets in which magnetic poles are disposed in opposite directions.

12. The shake correction device according to claim 1,
wherein the first magnet, the second magnet, and the movable unit constitute a magnetic circuit.

13. The shake correction device according to claim 12,
wherein the movable unit is moved in a plane parallel to an imaging surface of the imaging element by using the magnetic circuit and a current flowing through the first coil member.

14. The shake correction device according to claim 1, further comprising:
a biasing member that biases the movable unit toward the fixed unit.

15. The shake correction device according to claim 1,
wherein the first width is 1.2 or more and 1.3 or less in a case where the second width is 1.

16. The shake correction device according to claim 3,
wherein the first magnetic flux density is 1.00 or more and 1.025 or less in a case where the second magnetic flux density is set to 1.

17. The shake correction device according to claim 8,
wherein a thrust force of the movable unit at an end part of a movable range of the second yoke is decreased as compared with a thrust force of the movable unit at a center of the movable range.

18. The shake correction device according to claim 17,
wherein a degree of the decrease is 20% or less.

19. The shake correction device according to claim 1,
wherein the holding member further holds a second coil member, and
the first coil member is a coil member for moving the movable unit in a first direction, and the second coil member is a coil member for moving the movable unit in a second direction intersecting the first direction.

20. The shake correction device according to claim 19,
wherein the second coil member has different shapes at a first end part close to the imaging element and a second end part far from the imaging element.

21. The shake correction device according to claim 20,
wherein the second end part has a width narrower than a width of the first end part.

22. The shake correction device according to claim 19,
wherein at least a magnetic sensor is provided inside the second coil member.

23. The shake correction device according to claim 19,
wherein the holding member has a recessed portion in a first holding portion far from the imaging element in a holding portion that holds the first coil member and the second coil member.
